(19) United States
(12) Patent Application Publication
(10) Pub. No.: US 2026/0304155 A1
(43) Pub. Date: Oct. 1, 2026

(54) COMPUTERIZED SYSTEMS AND METHODS FOR A NETWORK MANAGEMENT FRAMEWORK

(71) Applicant: RESIDEO LLC, Golden Valley, MN (US)

(72) Inventors: Kevin Piel, Ronkonkoma, NY (US); Michael Garavuso, Boynton Beach, FL (US); David Walker, Smithtown, NY (US); William R. Blum, Huntington Station, NY (US)

(73) Assignee: RESIDEO LLC, Golden Valley, MN (US)

(21) Appl. No.: 19/489,389

(22) PCT Filed: Jun. 12, 2024
(86) PCT No.: PCT/US2024/033537

§ 371 Date: Dec. 2, 2025

Related U.S. Application Data
(60) Provisional application No. 63/507,821, filed on Jun. 13, 2023.
(60) Provisional application No. 63/508,034, filed on Jun. 14, 2023.
(60) Provisional application No. 63/509,827, filed on Jun. 23, 2023.
(60) Provisional application No. 63/510,530, filed on Jun. 27, 2023.
(60) Provisional application No. 63/510,424, filed on Jun. 27, 2023.

(51) Int. Cl. H04W 24/02; H04L 41/0806; H04L 41/5067

(52) U.S. Cl. CPC H04W 24/02; H04L 41/0806; H04L 41/5067

(57) ABSTRACT

Disclosed are systems and methods that provide a computerized network management framework that adaptively configures a network at a location based on computational analysis of network traffic, activity and/or parameters about the network, and/or devices and/or applications executing thereon. The framework can leverage information related to network functionality, capacity and coverage against network activity (e.g., upload/download, streaming, and the like) of devices connected to the network to determine a Quality of Service (QoS) for the network for network at a current or predetermined time. Such QoS can enable network modifications, device control and/or notifications to users, devices and/or services providers which can cause modifications and/or alterations to the network, at least according to particular device usage on the network.

### CROSS REFERENCE TO RELATED APPLICATIONS

This application claims the benefit of priority from U.S. Provisional Application No. 63/507,821, filed Jun. 13, 2023; No. 63/508,034, filed Jun. 14, 2023; No. 63/509,827, filed Jun. 23, 2023; No. 63/510,530, filed Jun. 27, 2023; and No. 63/510,424, filed Jun. 27, 2024; whereby the contents of which are each incorporated herein by reference in their entirety.

### FIELD OF THE DISCLOSURE

The present disclosure is generally related to network management, and more particularly, to managing and/or controlling network components and/or parameters of a network at a location.

### BACKGROUND

Current network management technologies provide management tools that administrators can utilize to view network metrics in order to conduct network traffic and/or activities based thereon.

### SUMMARY OF THE DISCLOSURE

The disclosed systems and methods provide an improved computerized network management framework that adaptively identifies and configures network parameters/characteristics of a network at a location based on determined intelligence about the network, and/or devices and/or applications executing thereon. The disclosed framework enables the network to identify and/or control its parameters, as well as manage the network traffic and interacting entities thereon so as to ensure that a subscribed Quality of Service (QoS) is maintained.

According to some embodiments, as discussed herein, the disclosed framework can leverage information related to network functionality, capacity and coverage against network activity (e.g., upload/download, streaming, and the like) of devices connected to the network to determine a Quality of Service (QoS) for the network at a current or predetermined time. As discussed herein, among other benefits, such QoS can enable network modifications, device control and/or notifications to users, devices and/or services providers which can cause modifications and/or alterations to the network, at least according to particular device usage on the network.

Accordingly, as discussed herein, the disclosed framework can provide an adaptive network management that involves dynamic, adaptive network configuration functionality and performance control, as well as improved security features.

According to some embodiments, a method is disclosed for computationally managing and/or controlling network components and/or parameters of a network at a location. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for computationally managing and/or controlling network components and/or parameters of a network at a location.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 is a block diagram of an example configuration within which the systems and methods disclosed herein could be implemented according to some embodiments of the present disclosure;

FIG. 5 is a block diagram illustrating components of an exemplary system according to some embodiments of the present disclosure;

FIG. 6 illustrates an exemplary workflow according to some embodiments of the present disclosure;

FIG. 7 is a block diagram of an example configuration within which the systems and methods disclosed herein could be implemented according to some embodiments of the present disclosure;

FIG. 8 is a block diagram illustrating components of an exemplary system according to some embodiments of the present disclosure;

FIG. 9 illustrates an exemplary workflow according to some embodiments of the present disclosure;

FIG. 10 is a block diagram of an example configuration within which the systems and methods disclosed herein could be implemented according to some embodiments of the present disclosure;

FIG. 11 is a block diagram illustrating components of an exemplary system according to some embodiments of the present disclosure;

FIG. 12 illustrates an exemplary workflow according to some embodiments of the present disclosure;

FIG. 13 is a block diagram of an example configuration within which the systems and methods disclosed herein could be implemented according to some embodiments of the present disclosure;

FIG. 14 is a block diagram illustrating components of an exemplary system according to some embodiments of the present disclosure;

FIG. 15 illustrates an exemplary workflow according to some embodiments of the present disclosure;

FIG. 16 depicts an exemplary implementation of an architecture according to some embodiments of the present disclosure;

FIG. 17 depicts an exemplary implementation of an architecture according to some embodiments of the present disclosure; and

FIG. 18 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a“network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures.

### Quality of Service-Based Network Configuration and Implementation

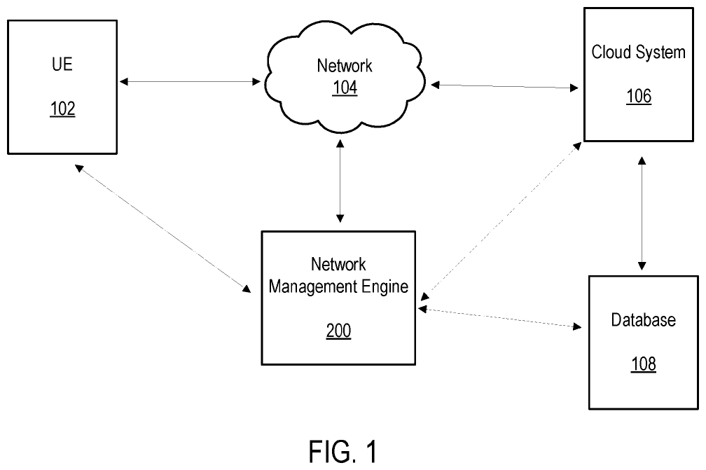

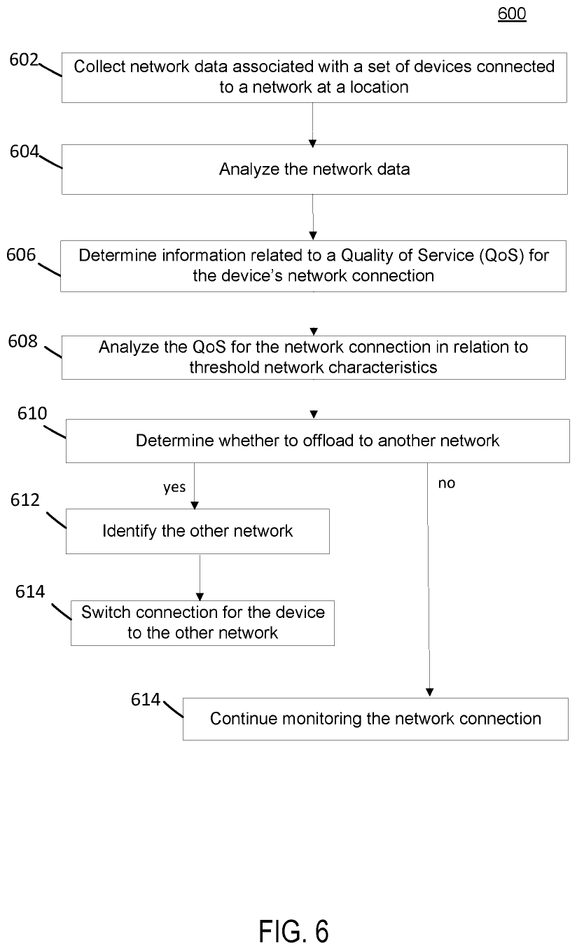

With reference to FIG. 1, system 100 is depicted which includes user equipment (UE) 102 (e.g., a client device, as mentioned above and discussed below in relation to FIG. 6), network 104, cloud system 106, database 108 and network management engine 200. It should be understood that while system 100 is depicted as including such components, it should not be construed as limiting, as one of ordinary skill in the art would readily understand that varying numbers of UEs, sensors, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, a router, modem, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, UE 102 can be a sensor that can be associated with a location of system 100. In some embodiments, such sensors can be, for example, but are not limited to, cameras, glass break detectors, motion detectors, door and window contacts, heat and smoke detectors, carbon monoxide (CO₂) detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. Thus, the sensors can be, wholly or in part, part of an IoT sensor network. For example, the sensors can include the sensors on UE 102 (e.g., smart phone, a paired smart watch, and the like).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a location monitoring and control system provider (e.g., Resideo®), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or network management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

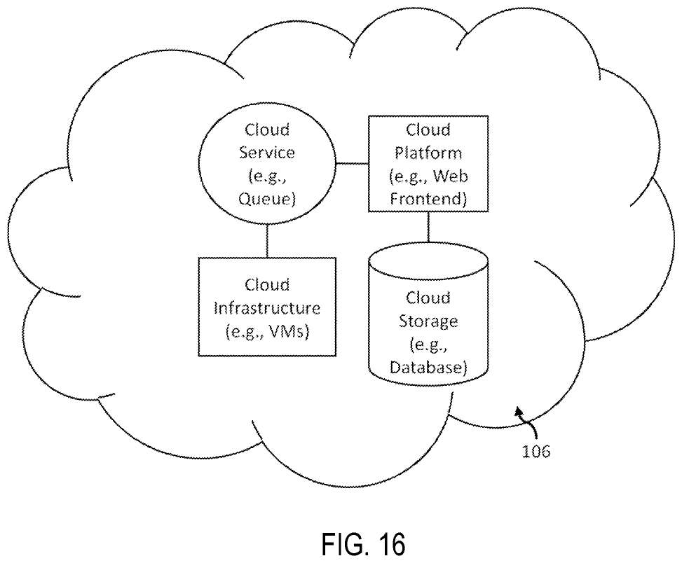

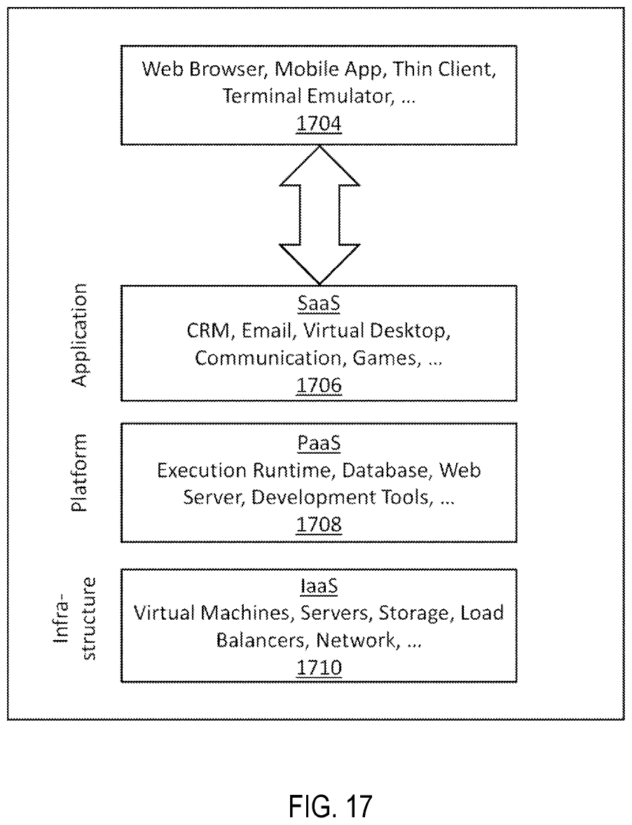

Turning to FIG. 16 and FIG. 17, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 1710, platform as a service (PaaS) 1708, and/or software as a service (SaaS) 1706 using a web browser, mobile app, thin client, terminal emulator or other endpoint 1704. FIG. 16 and FIG. 17 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Network management engine 200, as discussed above and further below in more detail, can include components for the disclosed functionality. According to some embodiments, network management engine 200 may be a special purpose machine or processor, and can be hosted by a device on network 104, within cloud system 106, and/or on UE 102. In some embodiments, engine 200 may be hosted by a server and/or set of servers associated with cloud system 106.

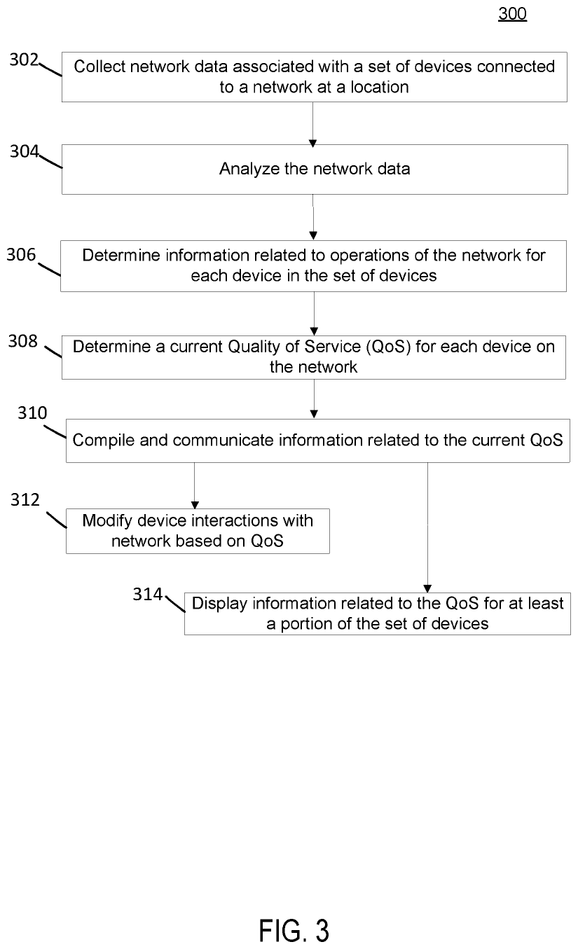

According to some embodiments, as discussed in more detail below, network management engine 200 may be configured to implement and/or control a plurality of services and/or microservices, where each of the plurality of services/microservices are configured to execute a plurality of workflows associated with performing the disclosed network management. Non-limiting embodiments of such workflows are provided below in relation to at least FIG. 3.

According to some embodiments, as discussed above, network management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

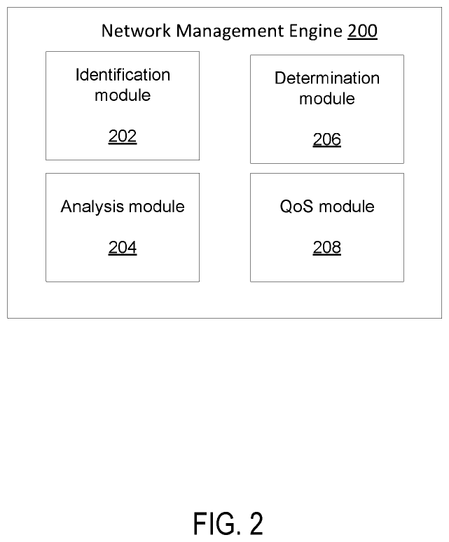

As illustrated in FIG. 2, according to some embodiments, network management engine 200 includes identification module 202, analysis module 204, determination module 206 and QoS module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed network management framework. As discussed herein, the disclosed framework, via engine 200, can effectuate identification of network traffic information, which can cause notifications related thereto and/or modification of the network based on determined QoS values/information.

According to some embodiments, Step 302 of Process 300 can be performed by identification module 202 of network management engine 200; Step 304 can be performed by analysis module 204; Steps 306 and 308 can be performed by determination module 206; and Steps 310-314 can be performed by QoS module 208.

According to some embodiments, Process 300 begins with Step 302 where engine 200 can collect network data associated with a set of devices connected to a network at a location (e.g., home, office, and the like). In some embodiments, the collection of network data can be based on, but not limited to, detection of an event and/or criteria, which can correspond to, but is not limited to, a device connected to the network, a threshold number of devices connecting to the network, an outage (e.g., network speeds dropping below a threshold value), a scheduled time/date, a type of request on the network, a detected amount of bandwidth usage, a detected amount of packet loss and/or packets being transferred, and the like.

In some embodiments, the network data can correspond to any type of data related to network connectivity and/or network traffic, including, but not limited to, downloads, uploads, connections to the network and/or other devices, bandwidth, latency, packet size, transmission power, transmission speed/frequency, and the like. In some embodiments, the network data can be, but is not limited to, specific to users, networks, applications, devices, locations, time periods, and the like, or some combination thereof.

In Step 304, engine 200 can analyze the network data. According to some embodiments, engine 200 can implement any type of known or to be known computational analysis technique, algorithm, mechanism or technology to analyze the collected data from Step 304.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, in Step 306, based on the analysis performed in Step 304, engine 200 can determine information related to a status of the network for each device within the set of devices. The status can provide, but is not limited to, statistical values indicating a respective device's current network usage, traffic and/or other parameters, which can, among other types of information, be based on and/or compared against predetermined values for the network. For example, if the network is set to provide 500 Mbps (as per the user's subscription for the location, for example), then this number can be compared against and the currently (determined via Step 306) provided 250 Mbps. In some embodiments, such illustrative comparison can further be indicative of the number of other devices connected at the location, which can provide an indicator as to why/how the network is degraded below the values per the subscription.

In Step 308, engine 200 can determine a QoS for each device on the network. According to some embodiments, as discussed herein, a QoS refers to the ability of a network to provide different levels of priority and service quality to different types of network traffic for each device on the network. In some embodiments, QoS can be represented as a set of techniques and mechanisms implemented in network infrastructure to ensure reliable and efficient transmission of data. In some embodiments, the QoS, as discussed herein, can be utilized to manage network resources effectively, prioritize critical traffic over non-critical traffic, and guarantee a certain level of performance for specific applications or services.

In some embodiments, QoS can involve, but is not limited to, several key components and features that work together to achieve this objective: bandwidth allocation, traffic classification, traffic prioritization, congestion management and resource reservation.

In some embodiments, with regard to bandwidth allocation, QoS mechanisms can enable determinations and implementations of allocations of available network bandwidth among different types of traffic. This ensures that critical traffic, such as voice or video data, receives sufficient bandwidth to maintain its quality.

In some embodiments, with regard to traffic classification, QoS can classify network traffic into different categories based on predefined criteria such as source IP address, destination IP address, protocol and/or application type, and the like, or some combination thereof. By understanding the nature of traffic, network devices can apply appropriate QoS policies.

In some embodiments, with regard to traffic prioritization, QoS can enable the prioritization of specific traffic types over others. For example, real-time applications like Voice over Internet Protocol (VoIP) or video conferencing require low latency and minimal packet loss, so they may be given higher priority than less time-sensitive traffic like file downloads.

In some embodiments, with regard to congestion management, QoS mechanisms can assist in managing network congestion by implementing algorithms such as, but not limited to, Traffic Shaping, Traffic Policing and/or Queue Management, and/or any other type of known or to be known algorithm or technique that can control the flow of traffic, preventing network bottlenecks and ensuring fair resource sharing among different traffic classes.

In some embodiments, with regard to resource reservation, QoS can enable functions for the reservation of network resources in advance to guarantee a certain level of performance for specific applications or services. For example, this can be utilized and/or implemented when predictable and consistent performance is critical, such as in real-time multimedia applications.

Accordingly, by implementing QoS mechanisms, engine 200 can optimize network performance, minimize latency, control bandwidth utilization, and ensure a satisfactory user experience for critical applications and/or devices operating thereon. Moreover, QoS can provide functionality in networks where different types of traffic coexist, enabling efficient utilization of network resources and meeting the requirements of diverse applications and services.

In some embodiments, engine 200 can implement any of the above AI/ML models as discussed in relation to Step 304, discussed supra, in performing Step 308's QoS for the network and/or devices connected thereon.

In some embodiments, Step 308 can involve generating a profile, that can be stored in database 108, for each device of the set of devices. The profile for the devices can include information related to, but not limited to, the determined QoS, subscribed network service (e.g., quality and capacity) for the location, device information (e.g., the respective device and/or other devices connected at a time the QoS was determined), user information, and the like, or some combination thereof.

In Step 310, engine 200 can compile and communicate information related to the current QoS. In some embodiments, the information can be sent to, but not limited to, a network provider, UEs connected to the network, UEs providing the network at the location, an administrator, a user or users, an account(s) or service portal, and the like, or some combination thereon.

In some embodiments, the communication can involve executable operations that can address reasons behind the QoS, as in Step 312. For example, engine 200 can determine which operations can be performed to reduce interference. For example, engine 200 can determine that UE 1 is streaming a video for personal reasons, while UE 2 is on a work Zoom™ conference; therefore, engine 200 may throttle UE 1's network usage given the importance of UE 2's current activity. In some embodiments, the executable operation can be embodied as, but not limited to, hardware, software and/or firmware upgrades to the UEs on the network. For example, an instruction can cause a user's device to have an access port closed for a time period, which may lend towards resource preservation and prevent the device from accessing the network for a specific period of time.

In some embodiments, either in addition to Step 312 or in the alternative, Step 314 can be performed by engine 200, which can cause the compiled information to be displayed as an electronic report that provides information related to the QoS for at least a portion of the set of devices (e.g., a specific device or all the devices), which can depend on the receiving user/entity of the compiled communication display. In some embodiments, the report can be interactive, which can cause a display screen to modify its display interface to provide additional information as to specific QoS for a device(s)/network. For example, a QoS value may be deep-linked, where the collected network statistics (e.g., from Step 302) can be displayed upon interaction with the linked QoS value.

In some embodiments, the report can be provided any type of information collected, identified, determined, derived and/or relied upon in the performance of the steps of Process 300. For example, the QoS report can provide an indicated relationship of the QoS levels of the device's network performance as compared to the values the user is subscribed for. Indeed, the report can provide reasoning and/or mechanisms for remedying such deficiencies. Alternatively, the QoS report can provide an indication as to how the network is operating efficiency, as requested as per the network subscription from a network provider.

Thus, processing of the steps of Process 300 can enable QoS values or information to be leveraged to provide information indicating the current status and operational capacity and capabilities of a network at a location.

### Network Management and Connectivity Based on a Determined Quality of Service of a Connected Network

By way of background, current network management technologies involve roaming, network handoff and network discovery technologies. However, such technologies are focused on identifying networks to establish a connection due to device movement and/or network unavailability.

However, there currently does not exist functionality for devices to offload or switch to alternative networks when connectivity of the connected network is operating at or below capacity levels. That is, until the advent of the instant disclosure's functionality, modern network management systems, operating on network nodes and/or connected devices, failed to enable devices to switch to other networks upon determinations that the currently connected network was a sub-optimal connection.

Accordingly, the disclosed systems and methods address such shortcomings, among others, by providing an improved computerized network management framework that enables devices to automatically switch to available, alternate networks upon determinations that the current network connection is sub-optimal (e.g., not operating at a threshold level, which can correspond to subscribed capabilities, capabilities of the geography and/or capabilities of the nodes and/or devices involved in the connection).

Accordingly, in some embodiments, the disclosed framework can operate to leverage information related to network functionality, capacity and coverage at a location for a connected device(s), and determine a Quality of Service (QoS) for such device's network connection at a current or predetermined time. As discussed herein, among other benefits, such QoS can enable network modifications, device control and/or notifications to users, devices and/or services providers which can cause modifications and/or alterations to the network, at least according to particular device usage on the network.

As such, according to some embodiments, the determined QoS can enable functionality related to how a device operates, inclusive of how the devices interact with other devices, with the network and/or other available networks. In some embodiments, upon the QoS being determined to below operational threshold related to the network's connectivity capabilities, the disclosed framework can enable the discovery of other available devices which can facilitate securing more stable and/or operational networks for the device's operational sessions.

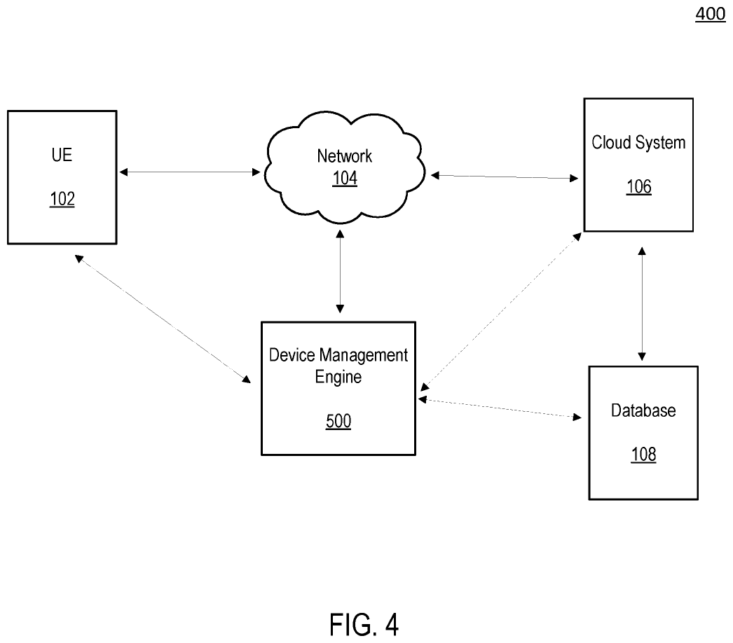

With reference to FIG. 4, system 400 is depicted which operates in a similar manner as discussed above in relation to system 100 in FIG. 1, supra. System 400 includes UE 102, network 104, cloud system 106, database 108 and device management engine 500. It should be understood that while system 400 is depicted as including such components, it should not be construed as limiting, as one of ordinary skill in the art would readily understand that varying numbers of UEs, sensors, peripheral devices, cloud systems, databases and networks can be utilized; however, for purposes of explanation, system 400 is discussed in relation to the example depiction in FIG. 4.

Device management engine 500, as discussed above and further below in more detail, can include components for the disclosed functionality. According to some embodiments, device management engine 500 may be a special purpose machine or processor, and can be hosted by a device on network 104, within cloud system 106, and/or on UE 102. In some embodiments, engine 200 may be hosted by a server and/or set of servers associated with cloud system 106.

According to some embodiments, as discussed in more detail below, device management engine 200 may be configured to implement and/or control a plurality of services and/or microservices, where each of the plurality of services/microservices are configured to execute a plurality of workflows associated with performing the disclosed network management. Non-limiting embodiments of such workflows are provided below.

According to some embodiments, as discussed above, device management engine 500 may function as an application provided by cloud system 106. In some embodiments, engine 500 may function as an application installed on a server(s), network location and/or other type of network resource associated with system 106. In some embodiments, engine 500 may function as an application installed and/or executing on UE 102. In some embodiments, such application may be a web-based application accessed by UE 102 over network 104 from cloud system 106. In some embodiments, engine 500 may be configured and/or installed as an augmenting script, program or application (e.g., a plug-in or extension) to another application or program provided by cloud system 106 and/or executing on UE 102.

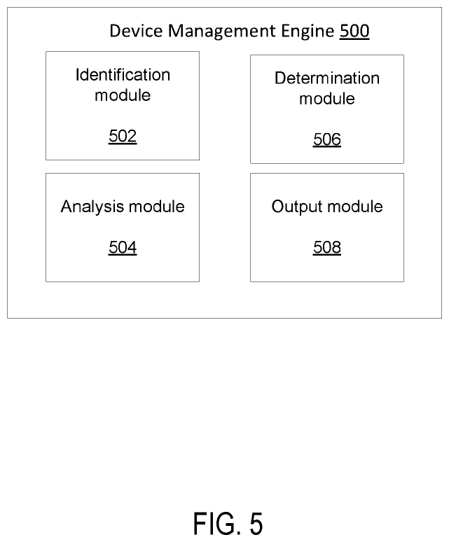

As illustrated in FIG. 5, according to some embodiments, device management engine 500 includes identification module 502, analysis module 504, determination module 506 and output module 508. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 500 and each of its modules, and their role within embodiments of the present disclosure will be discussed below.

Turning to FIG. 6, Process 600 provides non-limiting example embodiments for the disclosed network management framework. As discussed herein, the disclosed framework, via engine 500, can effectuate identification of network connectivity, traffic and/or activity information for a location, which can cause modifications in the manner in which a device operates at the location.

According to some embodiments, Step 602 of Process 600 can be performed by identification module 502 of device management engine 500; Steps 604 and 608 can be performed by analysis module 504; Steps 606 and 610 can be performed by determination module 506; and Steps 612-616 can be performed by output module 508.

It should be understood that while the discussion herein will be directed to a single device (e.g., UE 102) at a location, it should not be construed as limiting, as the processing of the steps of Process 600 can be performed for any number of devices at a location, either simultaneously, substantially simultaneously, and/or in sequential manner, without departing from the scope of the instant disclosure.

According to some embodiments, Process 600 begins with Step 602 where engine 500 can collect network data associated with a device (e.g., UE 102) connected to a network at a location (e.g., home, office, and the like). In some embodiments, the collection of network data can be based on, but not limited to, detection of an event and/or criteria, which can correspond to, but is not limited to, a device connected to the network, a threshold number of devices connecting to the network, an outage (e.g., network speeds dropping below a threshold value), a scheduled time/date, a type of request on the network, a detected amount of bandwidth usage, a detected amount of packet loss and/or packets being transferred, and the like.

In some embodiments, the network data can correspond to any type of data related to network connectivity and/or network traffic, including, but not limited to, downloads, uploads, connections to the network and/or other devices, bandwidth, latency, packet size, transmission power, transmission speed/frequency, and the like. In some embodiments, the network data can be, but is not limited to, specific to users, networks, applications, devices, locations, time periods, and the like, or some combination thereof.

In Step 604, engine 500 can analyze the network data. According to some embodiments, engine 500 can implement any type of known or to be known computational analysis technique, algorithm, mechanism or technology to analyze the collected data from Step 604.

In some embodiments, engine 500 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 500 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
g. define Neural Network architecture/model,
h. transfer the input data to the neural network model,
i. train the model incrementally,
j. determine the accuracy for a specific number of timesteps,
k apply the trained model to process the newly-received input data,
l. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, in Step 606, based on the analysis performed in Step 604, engine 500 can determine information related to the QoS for the device and/or the device's network connection. In some embodiments, the QoS can provide information related to values or metrics corresponding to, but not limited to, network usage, traffic and/or other parameters, which can, among other types of information, be based on and/or compared against predetermined values for the network. For example, if the network is set to provide 500 Mbps (as per the user's subscription for the location, for example), then this number can be compared against and the currently (determined via Step 606) provided 250 Mbps. Thus, for example, the QoS for the network throughput can be 50 percent.

In some embodiments, the QoS for a device's connection can be specific to a type of network parameter (e.g., latency, bandwidth, and the like), or can be an aggregate of at least a portion of available parameters for the analy zed connection. For example, the QoS can be specific to a parameter indicating current network connectivity (e.g., signal strength), or can be a general value that provides an overall score indicating the health of the network connection for the device.

Accordingly, in some embodiments, the QoS can refer to the ability of a network to provide different levels of priority and service quality to different types of network traffic for the device. In some embodiments, QoS can be represented as a set of techniques and mechanisms implemented in network infrastructure to ensure reliable and efficient transmission of data. In some embodiments, the QoS, as discussed herein, can be utilized to manage network resources effectively, prioritize critical traffic over non-critical traffic, and guarantee a certain level of performance for specific applications or services.

In some embodiments, QoS can involve, but is not limited to, several key components and features that work together to achieve this objective: bandwidth allocation, traffic classification, traffic prioritization, congestion management and resource reservation.

In some embodiments, with regard to bandwidth allocation, QoS mechanisms can enable determinations and implementations of allocations of available network bandwidth among different types of traffic. This ensures that critical traffic, such as voice or video data, receives sufficient bandwidth to maintain its quality.

In some embodiments, with regard to traffic classification, QoS can classify network traffic into different categories based on predefined criteria such as source IP address, destination IP address, protocol and/or application type, and the like, or some combination thereof. By understanding the nature of traffic, network devices can apply appropriate QoS policies.

In some embodiments, with regard to traffic prioritization, QoS can enable the prioritization of specific traffic types over others. For example, real-time applications like Voice over Internet Protocol (VoIP) or video conferencing require low latency and minimal packet loss, so they may be given higher priority than less time-sensitive traffic like file downloads.

In some embodiments, with regard to congestion management, QoS mechanisms can assist in managing network congestion by implementing algorithms such as, but not limited to, Traffic Shaping, Traffic Policing and/or Queue Management, and/or any other type of known or to be known algorithm or technique that can control the flow of traffic, preventing network bottlenecks and ensuring fair resource sharing among different traffic classes.

In some embodiments, with regard to resource reservation, QoS can enable functions for the reservation of network resources in advance to guarantee a certain level of performance for specific applications or services. For example, this can be utilized and/or implemented when predictable and consistent performance is critical, such as in real-time multimedia applications.

Accordingly, by implementing QoS mechanisms, engine 500 can optimize network performance, minimize latency, control bandwidth utilization, and ensure a satisfactory user experience for critical applications and/or devices operating thereon. Moreover, QoS can provide functionality in networks where different types of traffic coexist, enabling efficient utilization of network resources and meeting the requirements of diverse applications and services.

In some embodiments, engine 500 can implement any of the above AI/ML models as discussed in relation to Step 604, discussed supra, in performing Step 608's QoS for the network and/or devices connected thereon.

In some embodiments, Step 608 can involve storing information related to the device and/or the determined/collected network data, which can correspond to, but not be limited to, the determined QoS, subscribed network service (e.g., quality and capacity) for the location, device information (e.g., the respective device and/or other devices connected at a time the QoS was determined), device information, and the like, or some combination thereof.

In Step 610, engine 500 can perform a determination regarding whether to offload the device to another network that is currently available to the device. Such determination can be based on an analysis, via the AI/ML techniques discussed supra, of the QoS. For example, if the QoS is at or below a threshold level for a specific parameter (e.g., download speed, for example), then engine 500 can determine to switch networks.

In some embodiments, the determination in Step 610 can be based on projected or expected network values, which can correspond to subscribed activity. For example, as discussed above in another example, if the QoS for download speed is 50% (e.g., operating at 250 Mbps with a subscribed 500 Mbps capacity), since this QoS is below the threshold of 75%, engine 500 may determine to offload to another network with a better QoS ratio/value, as discussed infra.

In some embodiments, Step 610's determination can be based on, but not limited to, a weighted QoS score specific to a type of parameter, an aggregate of QoS scores for each network parameter, a type of device, a type of network, and the like. For example, download and bandwidth QoS values can be valued at higher levels, and therefore weighted more, than upload QoS values. Indeed, in some embodiments, such weighting and evaluation can be based on types of activities the device is performing. For example, if the device is uploading content rather than downloading, then QoS upload values may be weighted more.

Accordingly, in some embodiments, when engine 500 determines that the QoS for the current network connection of the device does not satisfy the QoS threshold, then engine 500 can proceed from Step 610 to Step 612. In Step 612, engine 500 can identify another network that is currently available to the device, and in Step 614, switch connection for the device to that other network. In some embodiments, the operations of Step 612-614 can involve identifying network data and QoS for such network, and determining that such QoS is i) at or above the threshold QoS values and/or ii) an improvement in QoS over the current network. In some embodiments, all available networks can be analyzed, whereby a top ranked/performing network can be identified in Step 612. Accordingly, such analysis and determination of QoS values can be performed in a similar manner as discussed above.

In some embodiments, when engine 500 determines that the QoS values of the current network connection satisfy the QoS threshold (or when there are no other networks with i) qualified and/or ii) better QoS values), engine 500 can proceed from Step 610 to Step 616. In Step 616, engine 500 can proceed to continued monitoring and collecting of network data.

Accordingly, upon performance of Step 614 or Step 616, engine 500 can recursively operate Process 600 by reverting back to Step 602 to monitor the connection for the new connection (via Step 614) of the maintained network connection (via Step 616).

### Device Management and Control Based on a Determined Quality of Service of a Connected Network

By way of background, current device management technologies involve providing updates and/or software patches to devices at non-peak hours. For example, updating a smart phone or sensor at a location during the night when user activity is deemed to correspond to minimal activity. This, however, falls short of performing quantitative actions that ascertain whether the update, for example, is capable of being installed given the current operating environment of the subject device

Accordingly, the disclosed systems and methods address such shortcomings, among others, by providing an improved computerized device management framework that leverages a device's current network operating environment to determine opportune times to provide system updates and/or upgrades. Rather than simply relying on non-peak hours, as in conventional systems, the disclosed framework can dynamically determine the optimal network characteristics of the network upon which a device is connected, and then matriculate instructions to modify how the device operates, which can include, but is not limited to, software updates, firmware updates, non-native functionality, applications, software kits, plug-ins, and the like, or some combination thereof.

Accordingly, in some embodiments, the disclosed framework can operate to leverage information related to network functionality, capacity and coverage at a location for a connected device(s) and determine a Quality of Service (QoS) for such device's network connection at a current or predetermined time. As discussed herein, among other benefits, such QoS can enable device modifications, device control and/or notifications to users, devices and/or services providers which can cause modifications and/or alterations to the devices connected at the location, at least according to particular device usage on the network.

As such, according to some embodiments, the determined QoS can enable functionality related to how a system updates/upgrades are provided to devices that can impact how such devices operate, inclusive of how the devices interact with other devices and/or receive executable instructions (e.g., related to upgrades, for example), with the network and/or other available networks.

According to some embodiments, as discussed herein, reference to system upgrades and/or updates, refer to device and/or network upgrades to a location's hardware, software and/or firmware. Thus, device and network upgrades (e.g., system upgrades/updates, used interchangeably) can refer to improvements made to either the hardware devices or the infrastructure that facilitates communication and connectivity between devices. These upgrades can enhance performance, expand capabilities, increase efficiency, and improve overall device and/or network functionality, as well as user experience, among other benefits.

By way of a non-limiting example, a device upgrade can involve, but is not limited to, upgrading a device's operating system to the latest version, which may offer new features, improved security, and better performance; increasing the RAM (random-access memory) or storage capacity of a device to handle more demanding tasks or store larger amounts of data: installing a faster and more powerful graphics card in a sensor to improve motion detection performance and graphics rendering, and the like.

By way of another non-limiting example, a network upgrade can involve, but is not limited to, upgrading a home Wi-Fi router to a newer model with improved range, faster speeds, and better network management features; transitioning from fourth-generation (4G) to fifth-generation (5G) technology, which offers significantly faster mobile data speeds and reduced latency, enabling new applications and capabilities; expanding network bandwidth via upgraded network subscriptions, and the like.

And, in another non-limiting example, upgrades/updates can further include, but are not limited to, implementing software-defined networking (SDN) solutions, which offer greater flexibility, centralized control, and improved network management in complex enterprise environments. Moreover, for example, upgrading network security infrastructure, such as firewalls and intrusion detection systems, can ensure robust protection against evolving cyber threats.

The above examples provide non-limiting use cases that illustrate how system updates/upgrades can be provided to improve a system's operation and performance, which can be efficiently and accurately enabled via the disclosed framework's operation, as discussed herein.

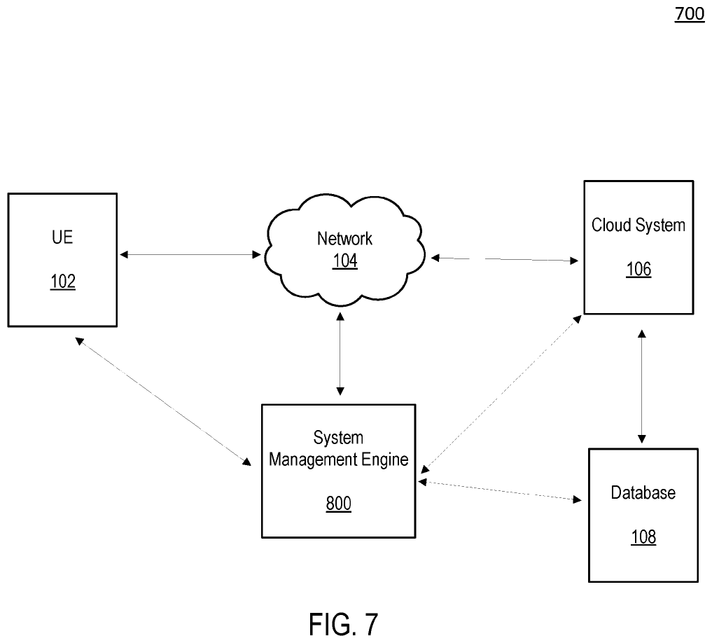

With reference to FIG. 7, system 700 operates in a similar manner as discussed above in relation to system 100 in FIG. 1, supra. System 700 includes UE 102, network 104, cloud system 106, database 108 and system management engine 800. It should be understood that while system 700 is depicted as including such components, it should not be construed as limiting, as one of ordinary skill in the art would readily understand that varying numbers of UEs, sensors, peripheral devices, cloud systems, databases and networks can be utilized; however, for purposes of explanation, system 700 is discussed in relation to the example depiction in FIG. 7.

System management engine 800, as discussed above and further below in more detail, can include components for the disclosed functionality. According to some embodiments, system management engine 800 may be a special purpose machine or processor, and can be hosted by a device on network 104, within cloud system 106, and/or on UE 102. In some embodiments, engine 800 may be hosted by a server and/or set of servers associated with cloud system 106.

According to some embodiments, as discussed in more detail below, system management engine 800 may be configured to implement and/or control a plurality of services and/or microservices, where each of the plurality of services/microservices are configured to execute a plurality of workflows associated with performing the disclosed network management. Non-limiting embodiments of such workflows are provided below.

According to some embodiments, as discussed above, system management engine 800 may function as an application provided by cloud system 106. In some embodiments, engine 800 may function as an application installed on a server(s), network location and/or other type of network resource associated with system 106. In some embodiments, engine 800 may function as an application installed and/or executing on UE 102. In some embodiments, such application may be a web-based application accessed by UE 102 over network 104 from cloud system 106. In some embodiments, engine 800 may be configured and/or installed as an augmenting script, program or application (e.g., a plug-in or extension) to another application or program provided by cloud system 106 and/or executing on UE 102.

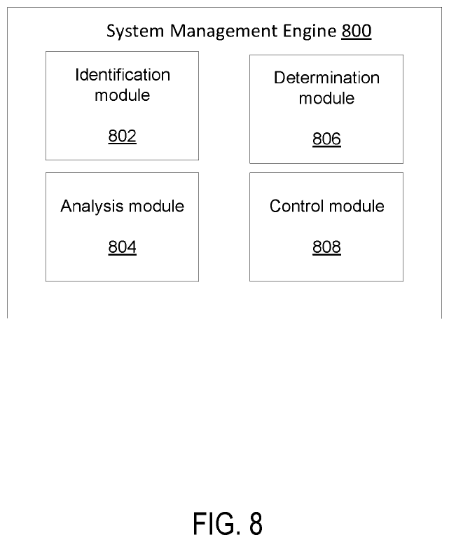

As illustrated in FIG. 8, according to some embodiments, system management engine 800 includes identification module 802, analysis module 804, determination module 806 and control module 808. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 800 and each of its modules, and their role within embodiments of the present disclosure will be discussed below.

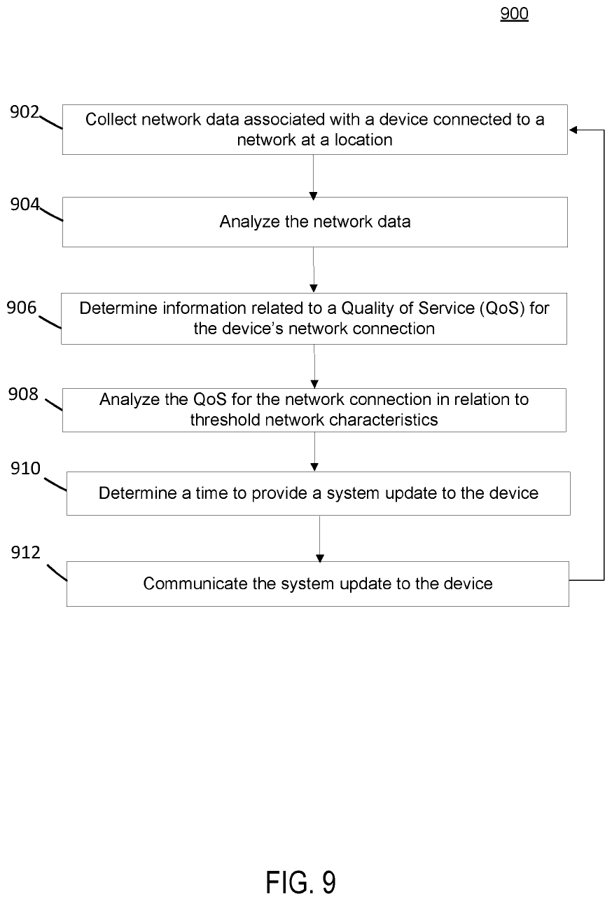

Turning to FIG. 9, Process 900 provides non-limiting example embodiments for the disclosed system management framework. According to some embodiments, the disclosed framework, via engine 800, can effectuate identification of network connectivity, traffic and/or activity information for a location, from which device and/or system upgrades can be effectuated in accordance with optimal network conditions, as discussed herein.

According to some embodiments, Step 902 of Process 900 can be performed by identification module 802 of system management engine 800; Steps 904 and 908 can be performed by analysis module 804; Steps 906 and 910 can be performed by determination module 806; and Step 912 can be performed by control module 808.

It should be understood that while the discussion herein will be directed to a single device (e.g., UE 102) at a location, it should not be construed as limiting, as the processing of the steps of Process 900 can be performed for any number of devices at a location, either simultaneously, substantially simultaneously, and/or in sequential manner, without departing from the scope of the instant disclosure.

According to some embodiments, Process 900 begins with Step 902 where engine 800 can collect network data associated with a device (e.g., UE 102) connected to a network at a location (e.g., home, office, and the like). In some embodiments, the collection of network data can be based on, but not limited to, detection of an event and/or criteria, which can correspond to, but is not limited to, a device connected to the network, a threshold number of devices connecting to the network, an outage (e.g., network speeds dropping below a threshold value), a scheduled time/date, a type of request on the network, a detected amount of bandwidth usage, a detected amount of packet loss and/or packets being transferred, a set of time intervals, and the like.

In some embodiments, the network data can correspond to any type of data related to network connectivity and/or network traffic, including, but not limited to, downloads, uploads, connections to the network and/or other devices, bandwidth, latency, packet size, transmission power, transmission speed/frequency, and the like. In some embodiments, the network data can be, but is not limited to, specific to users, networks, applications, devices, locations, time periods, and the like, or some combination thereof.

In Step 904, engine 800 can analyze the network data. According to some embodiments, engine 800 can implement any type of known or to be known computational analysis technique, algorithm, mechanism or technology to analyze the collected data from Step 902.

In some embodiments, engine 800 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 800 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
m. define Neural Network architecture/model,
n. transfer the input data to the neural network model,
o. train the model incrementally,
p. determine the accuracy for a specific number of timesteps,
q. apply the trained model to process the newly-received input data,
r. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, in Step 906, based on the analysis performed in Step 904, engine 800 can determine information related to the QoS for the device and/or the device's network connection. In some embodiments, the QoS can provide information related to values or metrics corresponding to, but not limited to, network usage, traffic and/or other parameters, which can, among other types of information, be based on and/or compared against predetermined values for the network. For example, if the network is set to provide 500 Mbps (as per the user's subscription for the location, for example), then this number can be compared against and the currently (determined via Step 906) provided 250 Mbps. Thus, for example, the QoS for the network throughput can be 50 percent.

In some embodiments, the QoS for a device's connection can be specific to a type of network parameter (e.g., latency, bandwidth, and the like), or can be an aggregate of at least a portion of available parameters for the analyzed connection. For example, the QoS can be specific to a parameter indicating current network connectivity (e.g., signal strength), or can be a general value that provides an overall score indicating the health of the network connection for the device.

Accordingly, in some embodiments, the QoS can refer to the ability of a network to provide different levels of priority and service quality to different types of network traffic for the device. In some embodiments, QoS can be represented as a set of techniques and mechanisms implemented in network infrastructure to ensure reliable and efficient transmission of data. In some embodiments, the QoS, as discussed herein, can be utilized to manage network resources effectively, prioritize critical traffic over non-critical traffic, and guarantee a certain level of performance for specific applications or services.

In some embodiments, QoS can involve, but is not limited to, several key components and features that work together to achieve this objective: bandwidth allocation, traffic classification, traffic prioritization, congestion management and resource reservation.

In some embodiments, with regard to bandwidth allocation, QoS mechanisms can enable determinations and implementations of allocations of available network bandwidth among different types of traffic. This ensures that critical traffic, such as voice or video data, receives sufficient bandwidth to maintain its quality.

In some embodiments, with regard to traffic classification, QoS can classify network traffic into different categories based on predefined criteria such as source IP address, destination IP address, protocol and/or application type, and the like, or some combination thereof. By understanding the nature of traffic, network devices can apply appropriate QoS policies.

In some embodiments, with regard to traffic prioritization, QoS can enable the prioritization of specific traffic types over others. For example, real-time applications like Voice over Internet Protocol (VoIP) or video conferencing require low latency and minimal packet loss, so they may be given higher priority than less time-sensitive traffic like file downloads.

In some embodiments, with regard to congestion management, QoS mechanisms can assist in managing network congestion by implementing algorithms such as, but not limited to, Traffic Shaping, Traffic Policing and/or Queue Management, and/or any other type of known or to be known algorithm or technique that can control the flow of traffic, preventing network bottlenecks and ensuring fair resource sharing among different traffic classes.

In some embodiments, with regard to resource reservation, QoS can enable functions for the reservation of network resources in advance to guarantee a certain level of performance for specific applications or services. For example, this can be utilized and/or implemented when predictable and consistent performance is critical, such as in real-time multimedia applications.

Accordingly, by implementing QoS mechanisms, engine 800 can optimize network performance, minimize latency, control bandwidth utilization, and ensure a satisfactory user experience for critical applications and/or devices operating thereon. Moreover, QoS can provide functionality in networks where different types of traffic coexist, enabling efficient utilization of network resources and meeting the requirements of diverse applications and services.

In some embodiments, engine 800 can implement any of the above AI/ML models as discussed in relation to Step 904, discussed supra, in performing Step 908's QoS for the network and/or devices connected thereon.

In some embodiments, Step 908 can involve storing information related to the device and/or the determined/collected network data, which can correspond to, but not be limited to, the determined QoS, subscribed network service (e.g., quality and capacity) for the location, device information (e.g., the respective device and/or other devices connected at a time the QoS was determined), device information, and the like, or some combination thereof.

Accordingly, in some embodiments, Step 908 can involve analyzing the QoS, as well as the features of the network, as discussed above, and determining time periods upon which the QoS is at a value at or above a particular QoS threshold. For example, bandwidth QoS for the device may be below a bandwidth QoS when other devices are connected to the network; however, when other devices or a threshold satisfying number of devices are connected to the network (e.g., less than X number of devices), the bandwidth QoS threshold may be satisfied.

In some embodiments, a predetermined or threshold number of QoS values must satisfy each of their QoS thresholds for a particular time to be identified, as discussed below.

In Step 910, engine 800 can perform a determination regarding identifying which time to provide a system update to the device. For example, when bandwidth of the network is at or above the QoS threshold, and signal strength QoS values are above signal strength thresholds, then a device can be scheduled for receiving a system upgrade. In some embodiments, the time determined may be based on information related to the upgrade, which can include, but not be limited to, a type of file, quantity of data, file size, download time, restart time, type of update/upgrade, type of device being updated/upgraded, type of functionality being provided, and the like.

Thus, in some embodiments, the information related to the system upgrade can impact how the time is selected. For example, for larger installations, a greater number of QoS values need to satisfy threshold; and in another example, for larger installations, a QoS threshold may need to be satisfied by a greater amount than for smaller installations given the anticipated network drain on available resources to the network.

Accordingly, in some embodiments, Step 910 can be performed via any of the AI/ML models discussed above, where QoS values from Step 906 and QoS threshold values from Step 908 can be provided as inputs, among other variables.

In some embodiments, the determined times for installations may be ranked, which can be stored and utilized by engine 800 to determine optimal times. In some embodiments, the ranking can function as a sequential queue of time data, whereby upon a first time in the queue being detected, an installation can be attempted. Should the install fail for any reason, then the next time in the queue can be relied upon for a subsequent attempt.

In Step 912, engine 800 can communicate the system update to the device, whereby the communication can occur at the determined time from Step 910. In some embodiments, the communication can cause the device to be automatically modified in accordance with the provided system update. Such updates, as discussed above, can be any type of update to a UE and/or network, which can modify capabilities of the device, network and/or interactions among devices and/or over the network, discussed supra.

### Device Failure Prediction

By way of background, device management technologies involve handling device failures, inclusive of device network failures in different ways depending on the device's capabilities and design.

According to some embodiments, as discussed herein, mechanisms for managing device failures include reconnection attempts, error handling, failover, caching, error reporting and timeouts.

With regard to reconnection attempts, when a network failure occurs, devices often try to reconnect to the network automatically. Devices may attempt to reconnect several times using different protocols or connection methods, such as switching between Wi-Fi and cellular data. Reconnection attempts may be initiated immediately after the failure or after a short delay.

Additionally, devices may implement error handling (or retry) mechanisms to deal with network failures. Devices may use various error codes and messages to identify a type of failure and take appropriate actions. For example, devices may retry failed network requests or resend packets that were not acknowledged.

In situations where devices have multiple network interfaces or access points available, they can employ failover or redundant mechanisms. For example, if one network fails, the device can automatically switch to an alternative network, maintaining connectivity. Redundancy can also be achieved by using multiple network devices, such as routers or switches, in a network infrastructure to ensure that a failure in one device does not result in a complete network outage.

Moreover, some devices and/or operating environments, such as web browsers or mobile apps, may employ caching (offline mode) techniques to store previously accessed data locally. For example, in the event of a network failure, these devices can use cached data to provide a limited level of functionality or access previously loaded content while offline. Once the network connection is restored, the devices can synchronize the cached data with the server.

With regard to error reporting (e.g., user notifications), devices can inform users about network failures through error messages or notifications. Accordingly, this can allow users to be aware of the issue and take appropriate actions, such as troubleshooting the network, contacting technical support, or waiting for the network to be restored.

To prevent devices from waiting indefinitely during network failures, they typically can use timeouts (or connection limits). If a connection or request takes too long to complete, the device may assume a failure and terminate the attempt. Additionally, devices may have limits on the number of concurrent connections they can handle, ensuring that network failures do not overwhelm their resources.

As such, according to some embodiments, specific mechanisms and strategies employed can vary depending on the type of device, operating system, and the software or applications running on a device.

The disclosed systems and methods address provide an improved computerized device management framework that leverages a device's current network operating environment to determine a Quality of Service (QoS) for the device's networking session (or operational environment), upon which control of the device, based at least on predicted network failures, can be effectuated. Accordingly, in some embodiments, the disclosed framework can operate to leverage information related to network functionality, capacity and coverage at a location for a connected device(s) to determine a QoS for such device's network connection at a current or predetermined time. Such QoS can be utilized to determine device and/or network failure events, inclusive of types of events, timing of such event and/or causes of such events. As such, as discussed herein, among other benefits, such QoS and failure prediction can enable device modifications, device control and/or notifications to users, devices and/or services providers which can cause modifications and/or alterations to the devices connected at the location, at least according to particular device usage on the network.

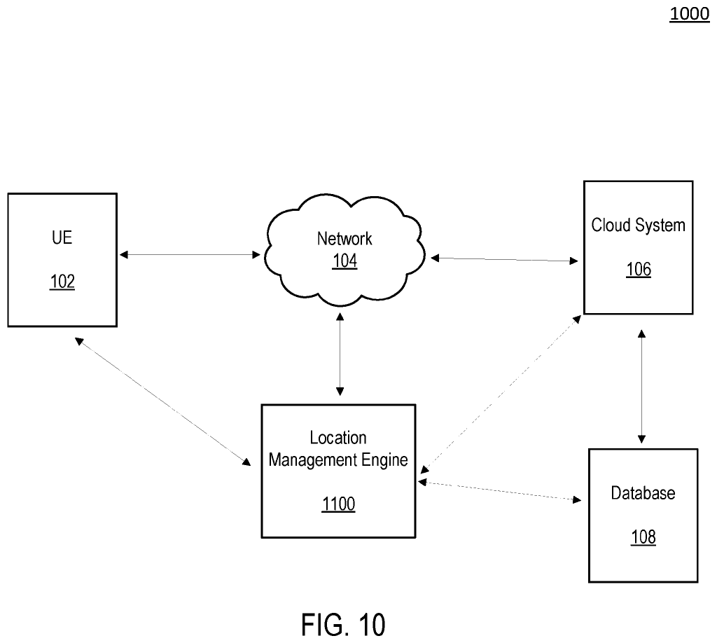

With reference to FIG. 10, system 1000 operates in a similar manner as discussed above in relation to system 100 in FIG. 1, supra. System 1000 includes UE 102, network 104, cloud system 106, database 108 and location management engine 1100. It should be understood that while system 1000 is depicted as including such components, it should not be construed as limiting, as one of ordinary skill in the art would readily understand that varying numbers of UEs, sensors, peripheral devices, cloud systems, databases and networks can be utilized; however, for purposes of explanation, system 1000 is discussed in relation to the example depiction in FIG. 10.

Location management engine 1100, as discussed above and further below in more detail, can include components for the disclosed functionality. According to some embodiments, location management engine 1100 may be a special purpose machine or processor, and can be hosted by a device on network 104, within cloud system 106, and/or on UE 102. In some embodiments, engine 1100 may be hosted by a server and/or set of servers associated with cloud system 106.

According to some embodiments, as discussed in more detail below, location management engine 1100 may be configured to implement and/or control a plurality of services and/or microservices, where each of the plurality of services/microservices are configured to execute a plurality of workflows associated with performing the disclosed device and/or location-based network management. Non-limiting embodiments of such workflows are provided below in relation to at least FIG. 3.

According to some embodiments, as discussed above, location management engine 1100 may function as an application provided by cloud system 106. In some embodiments, engine 1100 may function as an application installed on a server(s), network location and/or other type of network resource associated with system 106. In some embodiments, engine 1100 may function as an application installed and/or executing on UE 102. In some embodiments, such application may be a web-based application accessed by UE 102 over network 104 from cloud system 106. In some embodiments, engine 1100 may be configured and/or installed as an augmenting script, program or application (e.g., a plug-in or extension) to another application or program provided by cloud system 106 and/or executing on UE 102.

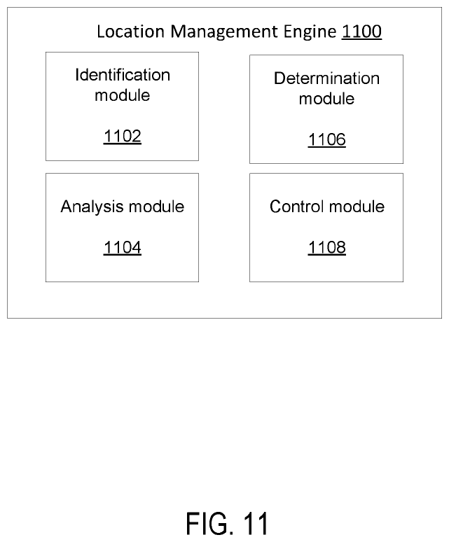

As illustrated in FIG. 11, according to some embodiments, location management engine 1100 includes identification module 1102, analysis module 1104, determination module 1106 and control module 1108. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 1100 and each of its modules, and their role within embodiments of the present disclosure will be discussed below.

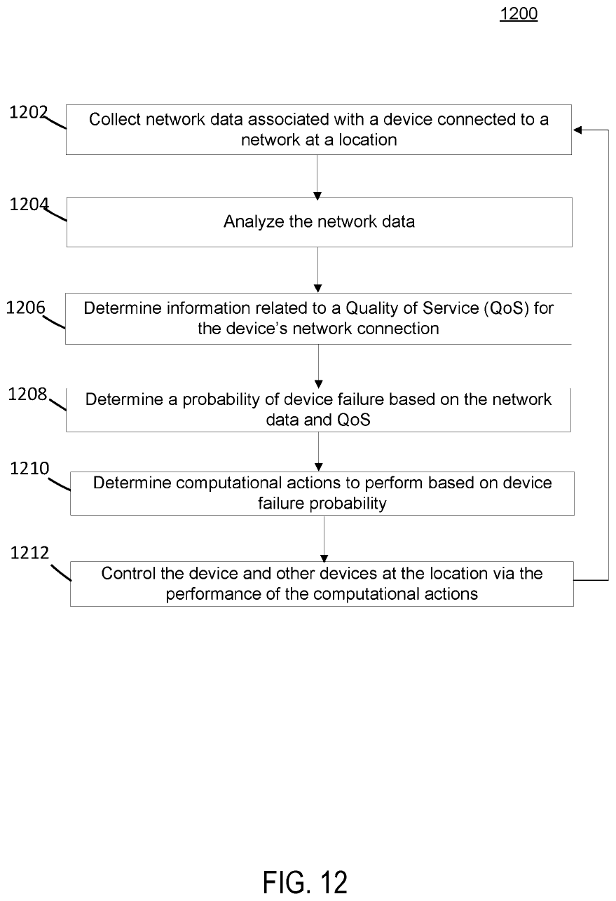

Turning to FIG. 12, Process 1200 provides non-limiting example embodiments for the disclosed system management framework. According to some embodiments, the disclosed framework, via engine 1100, can determine QoS values(s) (or metrics, or information) for a device's networking session (or operational environment), upon which control of the device, based at least one predicted network failures, can be effectuated. As discussed below, the disclosed framework can operate to leverage information related to the QoS to determine device/network failure events, inclusive of types of events, timing of such event and/or causes of such events. As such, as discussed herein, among other benefits, such QoS and failure prediction can enable device modifications, device control and/or notifications to users, devices and/or services providers which can cause modifications and/or alterations to the devices connected at the location, at least according to particular device usage on the network, as discussed herein.

According to some embodiments, Step 1202 of Process 1200 can be performed by identification module 1102 of location management engine 1100; Step 1204 can be performed by analysis module 1104; Steps 1206 and 1208 can be performed by determination module 1106; and Step 1212 can be performed by control module 1108.

It should be understood that while the discussion herein will be directed to a single device (e.g., UE 102) at a location, it should not be construed as limiting, as the processing of the steps of Process 1200 can be performed for any number of devices at a location, either simultaneously, substantially simultaneously, and/or in sequential manner, without departing from the scope of the instant disclosure.

According to some embodiments, Process 1200 begins with Step 1202 where engine 1100 can collect network data associated with a device (e.g., UE 102) connected to a network at a location (e.g., home, office, and the like). In some embodiments, the collection of network data can be based on, but not limited to, detection of an event and/or criteria, which can correspond to, but is not limited to, a device connected to the network, a threshold number of devices connecting to the network, an outage (e.g., network speeds dropping below a threshold value), a scheduled time/date, a type of request on the network, a detected amount of bandwidth usage, a detected amount of packet loss and/or packets being transferred, a set of time intervals, and the like.

In some embodiments, the network data can correspond to any type of data related to network connectivity and/or network traffic, including, but not limited to, downloads, uploads, connections to the network and/or other devices, bandwidth, latency, packet size, transmission power, transmission speed/frequency, and the like. In some embodiments, the network data can be, but is not limited to, specific to users, networks, applications, devices, locations, time periods, and the like, or some combination thereof.

In Step 1204, engine 1100 can analyze the network data. According to some embodiments, engine 1100 can implement any type of known or to be known computational analysis technique, algorithm, mechanism or technology to analyze the collected data from Step 1204.

In some embodiments, engine 1100 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 1100 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
s. define Neural Network architecture/model,
t. transfer the input data to the neural network model,
u. train the model incrementally,
v. determine the accuracy for a specific number of timesteps,
w. apply the trained model to process the newly-received input data,
x. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, in Step 1206, based on the analysis performed in Step 1204, engine 1100 can determine information related to the QoS for the device and/or the device's network connection. In some embodiments, the QoS can provide information related to values or metrics corresponding to, but not limited to, network usage, traffic and/or other parameters, which can, among other types of information, be based on and/or compared against predetermined values for the network. For example, if the network is set to provide 500 Mbps (as per the user's subscription for the location, for example), then this number can be compared against and the currently (determined via Step 1206) provided 250 Mbps. Thus, for example, the QoS for the network throughput can be 50 percent.

In some embodiments, the QoS for a device's connection can be specific to a type of network parameter (e.g., latency, bandwidth, and the like), or can be an aggregate of at least a portion of available parameters for the analyzed connection. For example, the QoS can be specific to a parameter indicating current network connectivity (e.g., signal strength), or can be a general value that provides an overall score indicating the health of the network connection for the device.

Accordingly, in some embodiments, the QoS can refer to the ability of a network to provide different levels of priority and service quality to different types of network traffic for the device. In some embodiments, QoS can be represented as a set of techniques and mechanisms implemented in network infrastructure to ensure reliable and efficient transmission of data. In some embodiments, the QoS, as discussed herein, can be utilized to manage network resources effectively, prioritize critical traffic over non-critical traffic, and guarantee a certain level of performance for specific applications or services.

In some embodiments, QoS can involve, but is not limited to, several key components and features that work together to achieve this objective: bandwidth allocation, traffic classification, traffic prioritization, congestion management and resource reservation.

In some embodiments, with regard to bandwidth allocation, QoS mechanisms can enable determinations and implementations of allocations of available network bandwidth among different types of traffic. This ensures that critical traffic, such as voice or video data, receives sufficient bandwidth to maintain its quality.

In some embodiments, with regard to traffic classification, QoS can classify network traffic into different categories based on predefined criteria such as source IP address, destination IP address, protocol and/or application type, and the like, or some combination thereof. By understanding the nature of traffic, network devices can apply appropriate QoS policies.

In some embodiments, with regard to traffic prioritization, QoS can enable the prioritization of specific traffic types over others. For example, real-time applications like Voice over Internet Protocol (VOIP) or video conferencing require low latency and minimal packet loss, so they may be given higher priority than less time-sensitive traffic like file downloads.

In some embodiments, with regard to congestion management, QoS mechanisms can assist in managing network congestion by implementing algorithms such as, but not limited to, Traffic Shaping, Traffic Policing and/or Queue Management, and/or any other type of known or to be known algorithm or technique that can control the flow of traffic, preventing network bottlenecks and ensuring fair resource sharing among different traffic classes.

In some embodiments, with regard to resource reservation, QoS can enable functions for the reservation of network resources in advance to guarantee a certain level of performance for specific applications or services. For example, this can be utilized and/or implemented when predictable and consistent performance is critical, such as in real-time multimedia applications.

Accordingly, by implementing QoS mechanisms, engine 1100 can optimize network performance, minimize latency, control bandwidth utilization, and ensure a satisfactory user experience for critical applications and/or devices operating thereon. Moreover, QoS can provide functionality in networks where different types of traffic coexist, enabling efficient utilization of network resources and meeting the requirements of diverse applications and services.

In some embodiments, Step 1206 can involve storing information related to the device and/or the determined/collected network data, which can correspond to, but not be limited to, the determined QoS, subscribed network service (e.g., quality and capacity) for the location, device information (e.g., the respective device and/or other devices connected at a time the QoS was determined), device information, and the like, or some combination thereof.

In Step 1208, engine 1100 can involve determining a probability of device failure. In some embodiments, the device failure can correspond to how likely the device is to operate at or below a threshold of functionality. For example, if the device is anticipated to function on the network at download speeds of 1200 Mbps, in Step 1208, engine 1100 can determine, based at least on the determined QoS and the network data, a probability (or likelihood) that such download speed (at least to a threshold range) can or will be attained.

In some embodiments, such probability can be based on, but not limited to, the QoS, network usage, type of activity, type of device, type of network, type of user account, type of user, number of other devices on the network, other types of actions by other users, geographic location, and the like, or some combination thereof.

In some embodiments, engine 1100 can implement any of the above AI/ML models as discussed in relation to Step 1204, discussed supra, in performing Step 1208's probability determination, whereby any of the above identified information discussed immediately above can function as input to such AI/ML model. Thus, in some embodiments, engine 1100 can analyze the QoS and network usage data, among other types of data, and determine a probability that the device may fail in performing such activity. In some embodiments, such failure prediction can indicate that the requested operation may not be completed and/or may timeout. For example, if a device is attempting to download a multimedia file, if the bandwidth related to the QoS indicates, upon the analysis of Step 1208, that such file cannot be properly downloaded without incurring timeouts and/or connectivity issues, then the determined likelihood would fall below the threshold level of the requested functionality.

In some embodiments, the threshold for the functionality can be variable, in that the threshold can shift based on, but not limited to, the type of requested functionality, a value of the QoS, and the like. For example, if the QoS is high, yet the functionality involves a large latency value, then the threshold may be at a higher degree/value given the larger hurdles for completion of the functionality as indicated by the QoS and latency value.

In some embodiments, Step 1208 can involve storing the information related to the determined probability/likelihood in database 108, in a similar manner as other storage operations, as discussed supra.

In Step 1210, engine 1100 can determine computational actions based on the device failure probability. In some embodiments, such actions can include, but are not limited to, reconnection attempts, error handling, failover, caching, error reporting and timeouts, as discussed above.

And, in Step 1212, engine 1100 can cause execution of the computational actions, which can cause the device to operate in a specific manner as dictated by the computational action. Such execution can be performed automatically, without user input, thereby enabling the QoS and device failure operations to be leveraged to manage automation of how a device operates on a network. In some embodiments, such operations can be performed for, but not limited to, identified other devices at the location, the device, and the like, or some combination thereof. Thus, in Step 1212, engine 1100 can determine which other devices are suffering from similar QoS and/or probability failure determination (e.g., same type of network issues), whereby they can be caused to act according to compiled instructions that can remedy the network/device failure. For example, if a connection is at or below a level that can enable a type of network action, such devices performing such actions at the time can be caused to change WiFi channels and/or device ports to enable their actions to be completed.

### Dynamic Installation Of System Components Based on Network Characteristics

Currently, device installations and configuration of such devices is a static task. That is, a device is preconfigured with functionality, and such functionality drives how the device operates on a location's network.

To that end, the disclosed systems and methods address such shortcomings, among others, by providing an improved computerized device configuration framework that leverages a location's current network operating environment, based on the capabilities of the devices connecting to such network, to determine specified configurations of such devices. According to some embodiments, network characteristics, as well as Quality of Service (QoS) of device's can be determined and leveraged to enable the device functionality to assimilate (or adhere) to the network's capacities. Thus, rather than configuring a network to how a device operates, the disclosure herein can enable devices at a location to adaptively modify their configurations and functionalities to maximize a network's coverage and capabilities.

According to some embodiments, as discussed in more detail below, the disclosed framework can dynamically determine the optimal or preferred network characteristics of the network upon which a device is connected, and then control how the device is configured to enable optimal and/or preferred device operations via such network connection. As discussed herein, such operations can be with reference to, but not limited to, types of activities, types of functionality, software updates, firmware updates, non-native functionality, applications, software kits, plug-ins, and the like, or some combination thereof.

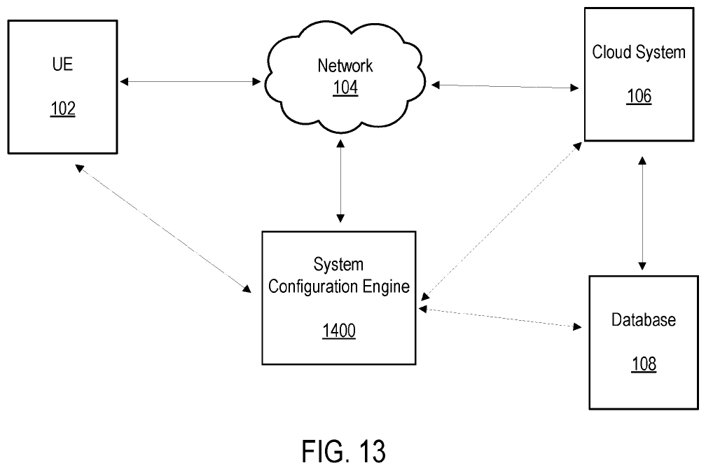

With reference to FIG. 13, system 1300 operates in a similar manner as discussed above in relation to system 100 in FIG. 1, supra. System 1300 includes UE 102, network 104, cloud system 106, database 108 and system configuration engine 1400. It should be understood that while system 100 is depicted as including such components, it should not be construed as limiting, as one of ordinary skill in the art would readily understand that varying numbers of UEs, sensors, peripheral devices, cloud systems, databases and networks can be utilized; however, for purposes of explanation, system 1300 is discussed in relation to the example depiction in FIG. 13.

System configuration engine 1400, as discussed above and further below in more detail, can include components for the disclosed functionality. According to some embodiments, system configuration engine 1400 may be a special purpose machine or processor, and can be hosted by a device on network 104, within cloud system 106, and/or on UE 102. In some embodiments, engine 1400 may be hosted by a server and/or set of servers associated with cloud system 106.

According to some embodiments, as discussed in more detail below, system configuration engine 1400 may be configured to implement and/or control a plurality of services and/or microservices, where each of the plurality of services/microservices are configured to execute a plurality of workflows associated with performing the disclosed network management. Non-limiting embodiments of such workflows are provided below.

According to some embodiments, as discussed above, system configuration engine 1400 may function as an application provided by cloud system 106. In some embodiments, engine 1400 may function as an application installed on a server(s), network location and/or other type of network resource associated with system 106. In some embodiments, engine 1400 may function as an application installed and/or executing on UE 102. In some embodiments, such application may be a web-based application accessed by UE 102 over network 104 from cloud system 106. In some embodiments, engine 1400 may be configured and/or installed as an augmenting script, program or application (e.g., a plug-in or extension) to another application or program provided by cloud system 106 and/or executing on UE 102.

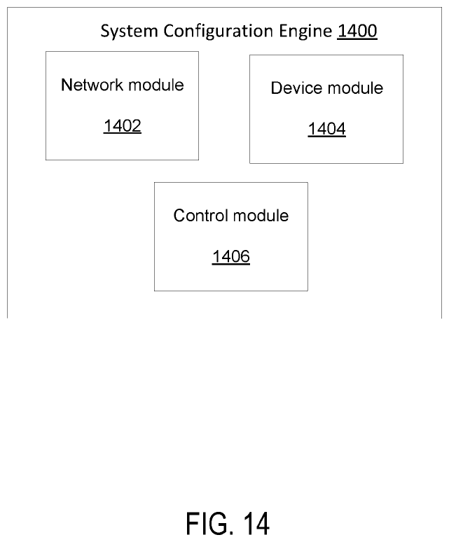

As illustrated in FIG. 14, according to some embodiments, system configuration engine 1400 includes network module 1402, device module 1404 and control module 1406. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 1400 and each of its modules, and their role within embodiments of the present disclosure will be discussed below.

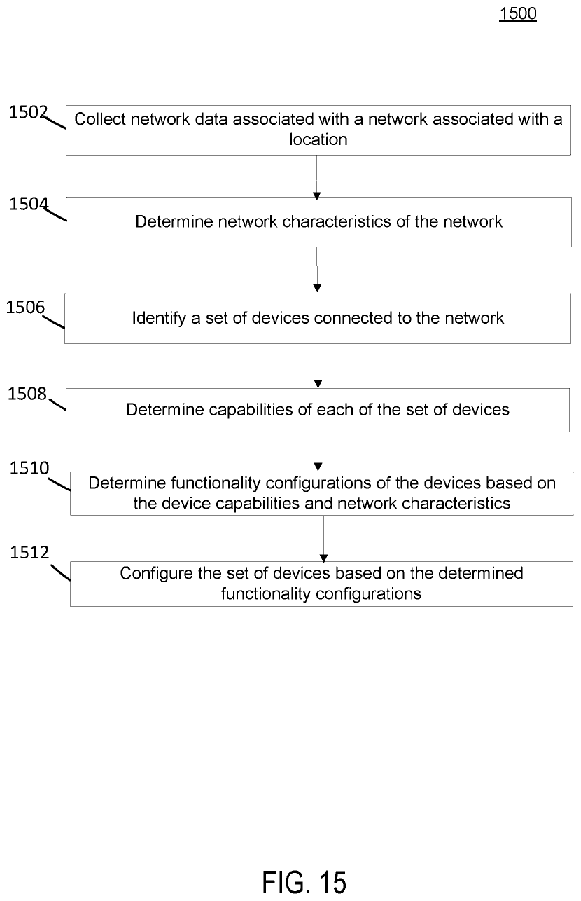

Turning to FIG. 15, Process 1500 provides non-limiting example embodiments for the disclosed system management framework. According to some embodiments, the disclosed framework, via engine 1400, can enable devices at a location to adaptively modify their configurations and functionalities to maximize a network's coverage and capabilities.

According to some embodiments, Steps 1502-1504 of Process 1500 can be performed by network module 1402 of system configuration engine 1400; Steps 1506-1508 can be performed by device module 1404; and Steps 1510-1512 can be performed by control module 1408.

It should be understood that while the discussion herein may be directed to a single device or set of devices (e.g., UE 102) at a location, it should not be construed as limiting, as the processing of the steps of Process 1500 can be performed for any number of devices at a location, either simultaneously, substantially simultaneously, and/or in sequential manner, without departing from the scope of the instant disclosure.

According to some embodiments, Process 1500 begins with Step 1502 where engine 1400 can collect network data of a network at a location (e.g., home, office, and the like). In some embodiments, the collection of network data can be based on, but not limited to, detection of an event and/or criteria, which can correspond to, but is not limited to, a device connected to the network, a threshold number of devices connecting to the network, an outage (e.g., network speeds dropping below a threshold value), a scheduled time/date, a type of request on the network, a detected amount of bandwidth usage, a detected amount of packet loss and/or packets being transferred, a set of time intervals, and the like.

In some embodiments, the network data can correspond to any type of data related to network connectivity and/or network traffic, including, but not limited to, downloads, uploads, connections to the network and/or other devices, bandwidth, latency, packet size, transmission power, transmission speed/frequency, and the like. In some embodiments, the network data can be, but is not limited to, specific to users, networks, applications, devices, locations, time periods, and the like, or some combination thereof.

In Step 1504, engine 1400 can analyze the network data and determine network characteristics of the network, which can correspond to a time period. According to some embodiments, engine 1400 can implement any type of known or to be known computational analysis technique, algorithm, mechanism or technology to analyze the collected data from Step 1502.

In some embodiments, engine 1400 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 1400 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
y. define Neural Network architecture/model,
z. transfer the input data to the neural network model,
aa. train the model incrementally,
bb. determine the accuracy for a specific number of timesteps,
cc. apply the trained model to process the newly-received input data,
dd. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, based on the analysis, engine 1400 can determine the information related to the network characteristics of the network, which can correspond to, but not be limited to, attributes, features, metadata, data, values, metrics, and the like, or some combination thereof. In some embodiments, the network characteristics information can be related to a current and/or time period-based QoS for the network. In some embodiments, the QoS can provide information related to values or metrics corresponding to, but not limited to, network usage, traffic and/or other parameters, which can, among other types of information, be based on and/or compared against predetermined values for the network. For example, if the network is set to provide 500 Mbps (as per the user's subscription for the location, for example), then this number can be compared against the currently provided 250 Mbps. Thus, for example, the QoS for the network throughput can be 50 percent.

In some embodiments, the QoS for a network connection can be specific to a type of network parameter (e.g., latency, bandwidth, and the like), or can be an aggregate of at least a portion of available parameters for the analyzed connection. For example, the QoS can be specific to a parameter indicating current network connectivity (e.g., signal strength), or can be a general value that provides an overall score indicating the health of the network connection for the device.

Accordingly, in some embodiments, the QoS can refer to the ability of a network to provide different levels of priority and service quality to different types of network traffic for the device. In some embodiments, QoS can be represented as a set of techniques and mechanisms implemented in network infrastructure to ensure reliable and efficient transmission of data. In some embodiments, the QoS, as discussed herein, can be utilized to manage network resources effectively, prioritize critical traffic over non-critical traffic, and guarantee a certain level of performance for specific applications or services.

In some embodiments, QoS can involve, but is not limited to, several key components and features that work together to achieve this objective: bandwidth allocation, traffic classification, traffic prioritization, congestion management and resource reservation.

In some embodiments, with regard to bandwidth allocation, QoS mechanisms can enable determinations and implementations of allocations of available network bandwidth among different types of traffic. This ensures that critical traffic, such as voice or video data, receives sufficient bandwidth to maintain its quality.

In some embodiments, with regard to traffic classification, QoS can classify network traffic into different categories based on predefined criteria such as source IP address, destination IP address, protocol and/or application type, and the like, or some combination thereof. By understanding the nature of traffic, network devices can apply appropriate QoS policies.

In some embodiments, with regard to traffic prioritization, QoS can enable the prioritization of specific traffic types over others. For example, real-time applications like Voice over Internet Protocol (VOIP) or video conferencing require low latency and minimal packet loss, so they may be given higher priority than less time-sensitive traffic like file downloads.

In some embodiments, with regard to congestion management, QoS mechanisms can assist in managing network congestion by implementing algorithms such as, but not limited to, traffic shaping, traffic policing and/or queue management, and/or any other type of known or to be known algorithm or technique that can control the flow of traffic, preventing network bottlenecks and ensuring fair resource sharing among different traffic classes.

In some embodiments, with regard to resource reservation, QoS can enable functions for the reservation of network resources in advance to guarantee a certain level of performance for specific applications or services. For example, this can be utilized and/or implemented when predictable and consistent performance is critical, such as in real-time multimedia applications.

Accordingly, by implementing QoS mechanisms, engine 1400 can optimize network performance, minimize latency, control bandwidth utilization, and ensure a satisfactory user experience for critical applications and/or devices operating thereon. Moreover, QoS can provide functionality in networks where different types of traffic coexist, enabling efficient utilization of network resources and meeting the requirements of diverse applications and services.

In Step 1506, engine 1400 can identify a set of devices. In some embodiments, the set of devices can be identified upon their connection to the network. In some embodiments, the devices can be identified via peripheral connections to other devices, whereby a proxy connection is established with the network. Accordingly, in some embodiments, upon a device connecting a network, engine 1400 can identify its presence on the network, whereby the following steps of Process 1500 can be performed.

In Step 1508, engine 1400 can determine capabilities and functionality of each of the set of devices identified in Step 1506. In some embodiments, such determined information can correspond to, but not be limited to, device type, software/applications installed on the device, operating system, device owner and/or user, input/output interfaces and/or ports, display capabilities, connectivity, location-sensing, and the like or some combination thereof. Accordingly, such capabilities and functionalities can correspond to any type of known or to be known operation a UE (discussed above) can be configured, programmed and/or built to perform.

In some embodiments, the determination in Step 1508 can be based on a request, ping or signal being sent to the device, whereby each device can respond with information related to such capabilities/functionality. In some embodiments, engine 1400 can utilize an application program interface (API) that can communicate with such device(s) via any type of network connectivity operations (e.g., Bluetooth, NFC, for example) and extract such capabilities information.

In Step 1510, engine 1400 can determine functionality configurations for each of the devices based on the determined capabilities (from Step 1508) and the determined network characteristics (from Step 1504). In some embodiments, the functional configurations for a device can be compiled and/or generated as an executable data structure of file, whereby instructions included or defined therein can be executed by a device so as to enable the device to operate in a particular manner. Accordingly, in some embodiments, the particular operations can enable the device to be configured to perform at an operational status that controls its capabilities (e.g., maximizes, throttles or minimizes, for example) based on other device operations on the network and the network's capacity and/or coverage.

In some embodiments, Step 1510 can include analyzing the device capabilities and the network characteristics as input to an AI/ML model, which can execute in a similar manner as discussed above at least in relation to Step 1504. Thus, engine 1400 can automatically determine executable instructions/files that can control how a device operates/functions on a network, in line with the network's requirements and requests on the network from other connected devices. For example, the functional configurations for a device can cause the device to adhere to current and/or predicted network capacities (e.g., lower frame rate on security camera, turn off certain sensors during peak QoS times, and the like).

In some embodiments, Step 1510 can further involve storing the functional capacities for each device, which can be effectuated via storage in database 108 and/or on each device. In some embodiments, upon the recursive performance of Process 1500 (e.g., additional collection of network data, and determination of different network characteristics and/or different capabilities for the devices and/or other devices, and the like), the stored functional capacities can be updated with more current information related to how the devices at the location are operating.

In some embodiments, as discussed above, functionality configurations can be determined for a single device, a set of devices, a subset of devices and/or all the devices at a location. Thus, in some embodiments, each device may be specifically configured based on their own capabilities in view of the network capabilities, and in some embodiments, the devices can be configured as an aggregate to function in a similar manner as part of a unified system.

In Step 1512, engine 1400 can configure each of the set of devices based on the determined functional configurations for each device. According to some embodiments, such configuration can include, but is not limited to, modifying how a device operates and/or connects to a network, installing a device on the network at the location, connecting a device to another device, configuring the device to operating in a different manner than initial and/or previous settings, and the like, or some combination thereof. Accordingly, such configurations can be caused via execution of the functionality configurations determined for each device in Step 1510.

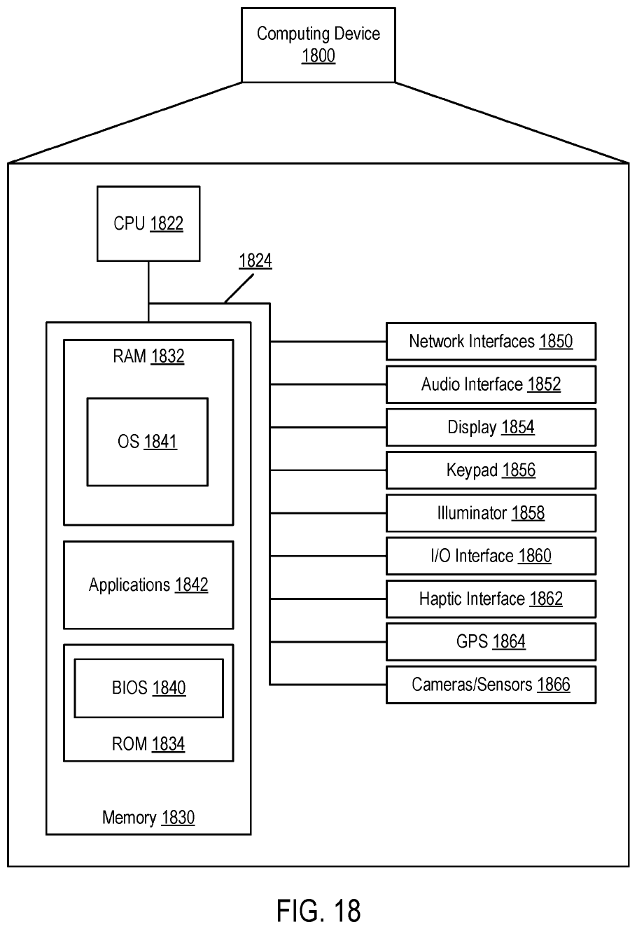

FIG. 18 is a schematic diagram illustrating a client device showing an example embodiment of a client device that may be used within the present disclosure. Client device 1800 may include many more or less components than those shown in FIG. 18. However, the components shown are sufficient to disclose an illustrative embodiment for implementing the present disclosure. Client device 1800 may represent, for example, UE 102 discussed above at least in relation to FIGS. 1, 4, 7, 10 and 13.

As shown in the figure, in some embodiments, Client device 1800 includes a processing unit (CPU) 1822 in communication with a mass memory 1830 via a bus 1824. Client device 1800 also includes a power supply 1826, one or more network interfaces 1850, an audio interface 1852, a display 1854, a keypad 1856, an illuminator 1858, an input/output interface 1860, a haptic interface 1862, an optional global positioning systems (GPS) receiver 1864 and a camera(s) or other optical, thermal or electromagnetic sensors 1866. Device 1800 can include one camera/sensor 1866, or a plurality of cameras/sensors 1866, as understood by those of skill in the art. Power supply 1826 provides power to Client device 1800.

Client device 1800 may optionally communicate with a base station (not shown), or directly with another computing device. In some embodiments, network interface 1850 is sometimes known as a transceiver, transceiving device, or network interface card (NIC).

Audio interface 1852 is arranged to produce and receive audio signals such as the sound of a human voice in some embodiments. Display 1854 may be a liquid crystal display (LCD), gas plasma, light emitting diode (LED), or any other type of display used with a computing device. Display 1854 may also include a touch sensitive screen arranged to receive input from an object such as a stylus or a digit from a human hand.

Keypad 1856 may include any input device arranged to receive input from a user. Illuminator 1858 may provide a status indication and/or provide light.

Client device 1800 also includes input/output interface 1860 for communicating with external. Input/output interface 1860 can utilize one or more communication technologies, such as USB, infrared, Bluetooth™, or the like in some embodiments. Haptic interface 1862 is arranged to provide tactile feedback to a user of the client device.

Optional GPS transceiver 1864 can determine the physical coordinates of Client device 1800 on the surface of the Earth, which typically outputs a location as latitude and longitude values. GPS transceiver 1864 can also employ other geo-positioning mechanisms, including, but not limited to, triangulation, assisted GPS (AGPS), E-OTD, CI, SAI, ETA, BSS or the like, to further determine the physical location of client device 1800 on the surface of the Earth. In one embodiment, however, Client device may through other components, provide other information that may be employed to determine a physical location of the device, including for example, a MAC address, Internet Protocol (IP) address, or the like.

Mass memory 1830 includes a RAM 1832, a ROM 1834, and other storage means. Mass memory 1830 illustrates another example of computer storage media for storage of information such as computer readable instructions, data structures, program modules or other data. Mass memory 1830 stores a basic input/output system (“BIOS”) 1840 for controlling low-level operation of Client device 1800. The mass memory also stores an operating system 1841 for controlling the operation of Client device 1800.

Memory 1830 further includes one or more data stores, which can be utilized by Client device 1800 to store, among other things, applications 1842 and/or other information or data. For example, data stores may be employed to store information that describes various capabilities of Client device 1800. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 1800.

Applications 1842 may include computer executable instructions which, when executed by Client device 1800, transmit, receive, and/or otherwise process audio, video, images, and enable telecommunication with a server and/or another user of another client device. Applications 1842 may further include a client that is configured to send, to receive, and/or to otherwise process gaming, goods/services and/or other forms of data, messages and content hosted and provided by the platform associated with engines 200, 500, 800, 1100 and/or 1400, and their affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
identifying, by a device, network data, the network data corresponding to network activity of a network of a location;
analyzing, by the device, the network data, and determining a set of network characteristics;
determining, by the device, based on the set of network characteristics, a Quality of Service (QoS) for the network, the QoS providing a current indication of network functionality, quality and capacity for devices at the location connected to the network;
generating, by the device, a profile for each of the devices at the location, the profile comprising information related to the determined QoS and subscribed network quality and capacity for the location; and
generating, by the device, a communication to at least one connected device, the communication providing an indication as to how the QoS relates to the subscribed network quality and capacity, the communication enabling a modification to the network by at least one connected device.

2. The method of claim 1, wherein the communication is displayed on a display of a device, the display provide capabilities for the modification to the network.

3. The method of claim 1, wherein the modification comprises changes to at least one of software, hardware and firmware of the devices at the location.

4. The method of claim 1, wherein the determined QoS for each device comprises information related to at least one of several key components and features that work together to achieve this objective: bandwidth allocation, traffic classification, traffic prioritization, congestion management and resource reservation.

5. The method of claim 1, wherein the set of network characteristics determined for each device corresponds to a status of each device, the status providing an indication as to the network functionality of the device at a current time.

6. The method of claim 1, wherein the collection of network data corresponds to a predetermined period of time at the location.

7. The method of claim 1, wherein the QoS is specific to each of the devices connected to the network.

8. The method of claim 1, wherein the network data corresponds to at least one of bandwidth, latency, packet size, transmission power and transmission frequency.

9. The method of claim 1, wherein the device is user equipment connected to the network.

10. The method of claim 1, wherein the device is user equipment providing the network.

11. A device comprising:
a processor configured to:
identify network data, the network data corresponding to network activity of a network of a location;
analyze the network data, and determining a set of network characteristics;
determine, based on the set of network characteristics, a Quality of Service (QoS) for the network, the QoS providing a current indication of network functionality, quality and capacity for devices at the location connected to the network;
generate a profile for each of the devices at the location, the profile comprising information related to the determined QoS and subscribed network quality and capacity for the location; and
generate a communication to at least one connected device, the communication providing an indication as to how the QoS relates to the subscribed network quality and capacity, the communication enabling a modification to the network by at least one connected device.

12. The device of claim 11, wherein the communication is displayed on a display of a device, the display provide capabilities for the modification to the network.

13. The device of claim 11, wherein the modification comprises changes to at least one of software, hardware and firmware of the devices at the location.

14. The device of claim 11, wherein the determined QoS for each device comprises information related to at least one of several key components and features that work together to achieve this objective: bandwidth allocation, traffic classification, traffic prioritization, congestion management and resource reservation.

15. The device of claim 11, wherein the set of network characteristics determined for each device corresponds to a status of each device, the status providing an indication as to the network functionality of the device at a current time.

16. A non-transitory computer-readable storage medium tangibly encoded with computer-executable instructions that when executed by a device, perform a method comprising:
identifying, by the device, network data, the network data corresponding to network activity of a network of a location;
analyzing, by the device, the network data, and determining a set of network characteristics;
determining, by the device, based on the set of network characteristics, a Quality of Service (QoS) for the network, the QoS providing a current indication of network functionality, quality and capacity for devices at the location connected to the network;
generating, by the device, a profile for each of the devices at the location, the profile comprising information related to the determined QoS and subscribed network quality and capacity for the location; and
generating, by the device, a communication to at least one connected device, the communication providing an indication as to how the QoS relates to the subscribed network quality and capacity, the communication enabling a modification to the network by at least one connected device.

17. The non-transitory computer-readable storage medium of claim 16, wherein the communication is displayed on a display of a device, the display provide capabilities for the modification to the network.

18. The non-transitory computer-readable storage medium of claim 16, wherein the modification comprises changes to at least one of software, hardware and firmware of the devices at the location.

19. The non-transitory computer-readable storage medium of claim 16, wherein the determined QoS for each device comprises information related to at least one of several key components and features that work together to achieve this objective: bandwidth allocation, traffic classification, traffic prioritization, congestion management and resource reservation.

20. The non-transitory computer-readable storage medium of claim 16, wherein the set of network characteristics determined for each device corresponds to a status of each device, the status providing an indication as to the network functionality of the device at a current time.

21-100. (canceled)
